(19) United States
(12) Patent Application Publication
(10) Pub. No.: US 2022/0366044 A1
(43) Pub. Date: Nov. 17, 2022

(54) LEARNING APPARATUS, DETERMINATION SYSTEM, LEARNING METHOD, AND NON-TRANSITORY COMPUTER READABLE MEDIUM

(71) Applicant: NEC Corporation, Minato-ku, Tokyo (JP)

(72) Inventor: Mikiya YOSHIDA, Tokyo (JP)

(73) Assignee: NEC Corporation, Minato-ku, Tokyo (JP)

(21) Appl. No.: 17/761,246

(22) PCT Filed: Aug. 24, 2020
(86) PCT No.: PCT/JP2020/031781

§ 371 Date: Mar. 17, 2022

(30) Foreign Application Priority Data
Sep. 26, 2019 (JP) 2019-175847

(51) Int. Cl. G06F 21/56

(52) U.S. Cl. CPC G06F 21/564; G06F 2221/033

(57) ABSTRACT

A learning apparatus includes a pseudo learning unit for creating a pseudo learning model based on pseudo feature data indicating a pseudo feature of goodware and a determination learning unit for creating a determination learning model for determining whether a file is malware based on the created pseudo learning model and feature data indicating a feature of the malware.

### TECHNICAL FIELD

The present disclosure relates to a learning apparatus, a determination system, a learning method, and a non-transitory computer readable medium.

### BACKGROUND ART

In recent years, machine learning, as represented by deep learning, has been actively studied and applied to various fields. For example, machine learning is being used to detect malware that continues to grow on the Internet every year.

As related art, for example, Patent Literature 1 and 2 are known. Patent Literature 1 discloses a technique for learning a communication feature amount of malware in order to detect malware. In addition, Patent Literature 2 discloses a technique for creating a normal model by unsupervised machine learning in order to detect an abnormality of a facility.

### CITATION LIST

### Patent Literature

### Patent Literature 1: Japanese Unexamined Patent Application Publication No. 2019-103069

### Patent Literature 2: Japanese Unexamined Patent Application Publication No. 2019-124984

### SUMMARY OF INVENTION

### Technical Problem

As disclosed in Patent Literature 1, a related technique uses machine learning to detect malware and learn a large number of features of the malware. However, in the related technique, there is a problem that it is sometimes difficult to create a learning model capable of accurately determining whether a file is malware.

In view of such a problem, an object of the present disclosure is to provide a learning apparatus, a determination system, a learning method, and a non-transitory computer readable medium capable of creating a learning model that can improve an accuracy of determining whether a file is malware.

### Solution to Problem

A learning apparatus according to the present disclosure includes: pseudo learning means for creating a pseudo learning model based on pseudo feature data indicating a pseudo feature of goodware; and determination learning means for creating a determination learning model for determining whether a file is malware based on the created pseudo learning model and feature data indicating a feature of the malware.

A determination system according to the present disclosure includes: pseudo learning means for creating a pseudo learning model based on pseudo feature data indicating a pseudo feature of goodware; determination learning means for creating a determination learning model for determining whether a file is malware based on the created pseudo learning model and feature data indicating a feature of the malware; and determination means for determining whether or not an input file is the malware based on the created determination learning model.

A learning method according to the present disclosure includes: creating a pseudo learning model based on pseudo feature data indicating a pseudo feature of goodware; and creating a determination learning model for determining whether a file is malware based on the created pseudo learning model and feature data indicating a feature of the malware.

A non-transitory computer readable medium storing a learning program according to the present disclosure causes a computer to execute: creating a pseudo learning model based on pseudo feature data indicating a pseudo feature of goodware; and creating a determination learning model for determining whether a file is malware based on the created pseudo learning model and feature data indicating a feature of the malware.

### Advantageous Effects of Invention

According to the present disclosure, it is possible to provide a learning apparatus, a determination system, a learning method, and a non-transitory computer readable medium capable of creating a learning model that can improve an accuracy of determining whether a file is malware.

### BRIEF DESCRIPTION OF DRAWINGS

FIG. 1 is a flowchart showing a related learning method;

FIG. 2 is a schematic diagram showing an outline of a learning apparatus according to example embodiments;

FIG. 3 is a schematic diagram showing an outline of a determination system according to example embodiments;

FIG. 4 is a block diagram showing a configuration example of a determination system according to a first example embodiment;

FIG. 5 is a flowchart showing a learning method according to the first example embodiment;

FIG. 6 shows an image of a pseudo-learning model created by the learning method according to the first example embodiment;

FIG. 7 shows an image of a determination learning model created by the learning method according to the first example embodiment;

FIG. 8 is a flowchart showing a determination method according to the first example embodiment; and

FIG. 9 is a block diagram showing a configuration example of a determination system according to a second example embodiment.

### DESCRIPTION OF EMBODIMENTS

Example embodiments will be described below with reference to the drawings. The following descriptions and drawings have been omitted and simplified as appropriate for clarification of the description. In each of the drawings, the same elements are denoted by the same reference signs, and repeated descriptions are omitted as necessary.

### Investigation Leading to Example Embodiments

As a related technique, a method for determining whether a file is malware using a learning model (a mathematical model) using deep learning will be investigated. In the method using the learning model, a large amount of feature data (numerical data) indicating features of malware and normal files are prepared, and a learning model is created using them. By learning a large amount of feature data of malware and normal files as supervised data, “features” common to the malware can be found and unknown malware can be determined. Note that malware is software or data that performs unauthorized (malicious) operations on a computer or a network, such as computer viruses or worms. A normal file (goodware) is a file other than malware, and is software or data that normally operates on a computer or a network without performing an unauthorized (malicious) operation.

The “feature data” indicating the feature of the malware is data obtained by digitizing the number of occurrences of a string pattern appearing in common with many kinds of malware, whether or not the malware matches a certain rule (e.g., “a certain file on computer is being operated”), etc. It is necessary to manually prepare in advance a list of string patterns and select rules to be used which are necessary for the creation of the feature data.

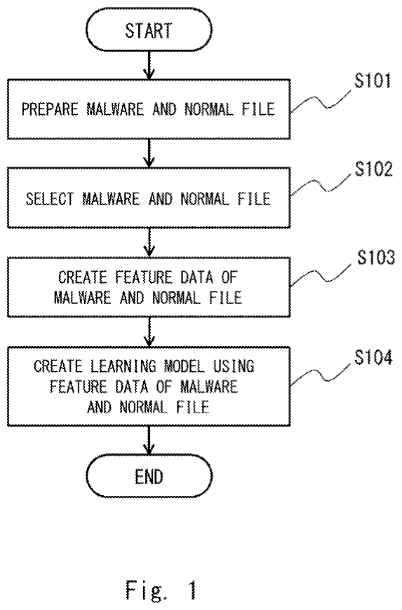

FIG. 1 shows a related learning method. As shown in FIG. 1, in the related learning method, a large number of samples of malware and normal files are prepared (S101), and the malware and normal files of the samples used for creating a learning model are selected (S102). Further, the feature data of the malware and the normal file of the selected samples is created (S103), and the learning model is prepared using the created feature data of the malware and the normal file (S104). At this time, a feature common to the malware of the sample and a feature common to the normal file of the sample are learned.

The inventor has found a problem that it is not possible to accurately determine whether a file is malware if a learning model obtained by such a related learning method is used. That is, when an unknown sample is evaluated using a learning model obtained by the related learning method, it is almost always determined to be “malware”. This is due to the lack of normal file samples compared to malware samples, and the inability to effectively learn the features of the normal files. For example, compared to about 2.5 million malware samples, only about 500,000 of the normal file samples, which is about ⅕ of the number of malware samples, can be prepared. A certain number of samples of the malware can be collected from existing databases of malware and information provided on the Internet. However, it is difficult to collect a large number of normal files, because there are hardly any such existing databases or information provided on the Internet regarding the normal files that are operating normally.

The above problem is also caused by algorithmic features of deep learning. Specifically, when there is a difference between the number of samples of malware and that of normal files, it is more likely that a file will be determined to be whichever one has a greater number of samples. Therefore, the learning model tends to determine a file to be “malware” having a greater number of samples. For example, when learning is performed using the feature data of malware only, a learning model that always determines a file to be “malware” is obtained. Therefore, in the related learning method, feature data of a normal file is essential in order to accurately determine whether a file is malware or a normal file.

Furthermore, the above problem is caused by the difficulty in acquiring the features of the “normal files”. That is, malware has common features such as “access to a specific file” and “call a specific Application Programming Interface (API)”. However, the normal files do not have such rules and do not have common features. It is therefore difficult to determine a normal file with the learning model created using the related learning method.

Thus, if a learning model created by the related learning method is used, it is not possible to accurately determine whether a file is malware. In order to address this issue, in the following example embodiments, even when the number of samples of normal files is small and it is difficult to acquire the features of the normal files, it is possible to accurately determine whether a file is malware.

### Outline of Example Embodiments

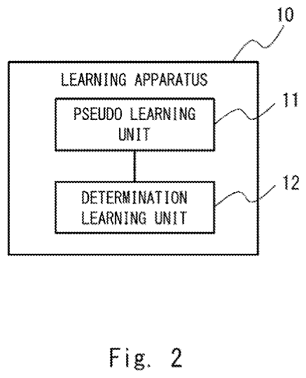

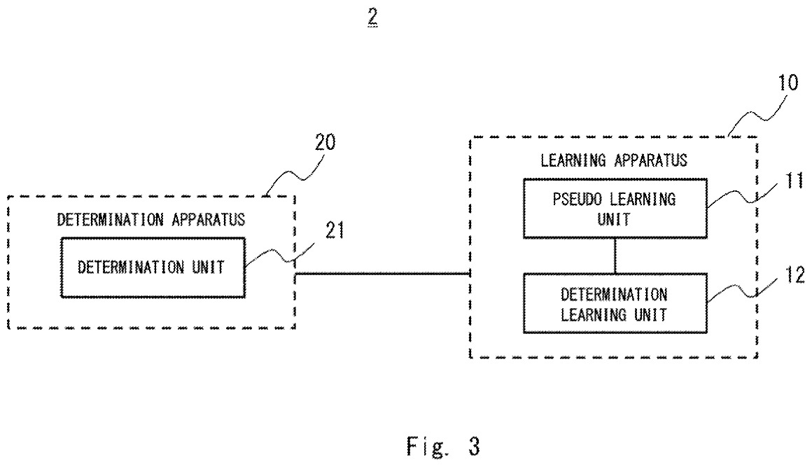

FIG. 2 shows an outline of a learning apparatus according to example embodiments, and FIG. 3 shows an outline of a determination system according to the example embodiments. As shown in FIG. 2, the learning apparatus 10 includes a pseudo learning unit (a first learning unit) 11 and a determination learning unit (a second learning unit) 12.

The pseudo learning unit 11 creates a pseudo learning model (a first learning model) based on pseudo feature data indicating a pseudo feature of a normal file (goodware). For example, the pseudo feature data is data that covers possible values of feature data within a possible range. The determination learning unit 12 creates a determination learning model (a second learning model) for determining whether a file is malware based on the pseudo learning model created by the pseudo learning unit 11 and the feature data indicating a feature of the malware.

As shown in FIG. 3, the determination system 2 includes the learning apparatus 10 and a determination apparatus 20. The determination apparatus 20 includes a determination unit 21 for determining whether or not an input file is malware based on the determination learning model created by the learning apparatus 10. In the determination system 2, the configurations of the learning apparatus 10 and the determination apparatus 20 are not limited thereto. That is, the determination system 2 is not limited to the configuration including the learning apparatus 10 and the determination apparatus 20, and includes at least the pseudo learning unit 11, the determination learning unit 12, and the determination unit 21.

Thus, in the example embodiments, the learning model is created in two stages: one stage in which a pseudo learning model is created based on the pseudo feature data of the normal file; and another stage in which the determination learning model is created based on the feature data of the malware. Thus, it is not necessary to learn the features of the normal files which are difficult to acquire, and a learning model capable of improving the accuracy of determining whether a file is malware can be created.

### First Example Embodiment

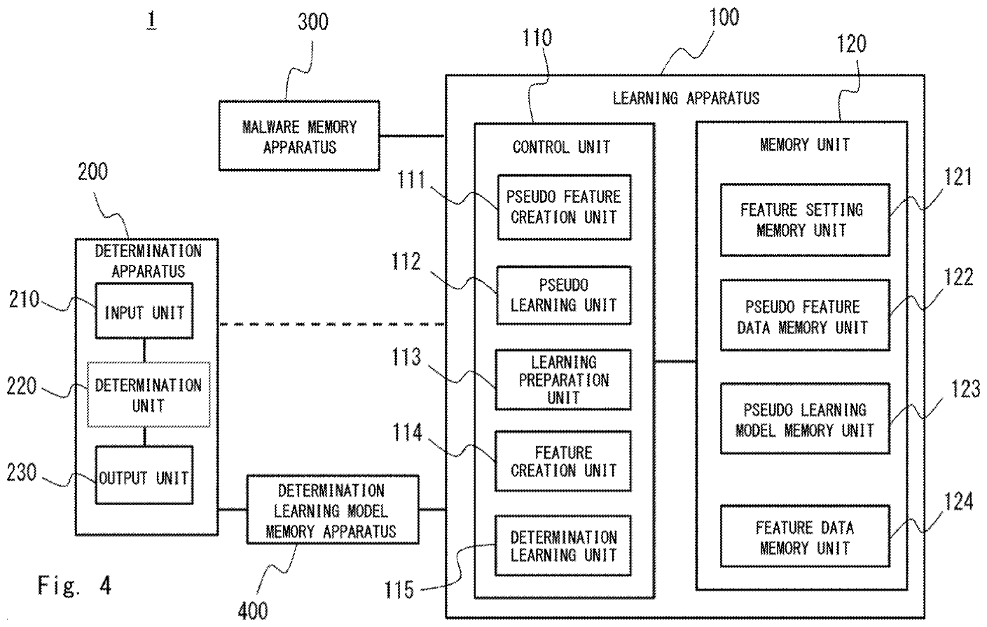

A first example embodiment will be described below with reference to the drawings. FIG. 4 shows a configuration example of the determination system 1 according to this example embodiment. The determination system 1 is a system for determining whether or not a file provided by a user is malware using a learning model trained with features of malware.

As shown in FIG. 4, for example, the determination system 1 includes a learning apparatus 100, a determination apparatus 200, a malware memory apparatus 300, and a determination learning model memory apparatus 400. For example, each apparatus of the determination system 1 is constructed on a cloud, and services of the determination system 1 are provided by SaaS (Software as a Service). That is, each apparatus is implemented by a computer apparatus such as a server or a personal computer, or may be implemented by one physical apparatus, or may be implemented by a plurality of apparatuses on a cloud by a virtualization technology or the like. The configuration of each apparatus and each unit (block) in the apparatus is an example, and may be composed of other apparatuses and units, respectively, if a method (operation) described later can be performed. For example, the determination apparatus 200 and the learning apparatus 100 may be integrated into one apparatus, or each apparatus may be composed of a plurality of apparatuses. The malware memory apparatus 300 and the determination learning model memory apparatus 400 may be included in the determination apparatus 200 and the learning apparatus 100. Further, memory units included in the determination apparatus 200 and the learning apparatus 100 may be external memory apparatuses.

The malware memory apparatus 300 is a database apparatus for storing a large amount of malware as samples for learning. The malware memory apparatus 300 may store previously collected malware or may store information provided on the Internet. The determination learning model memory apparatus 400 stores determination learning models (or simply called learning models) for determining whether a file is malware. The determination learning model memory apparatus 400 stores the determination learning models created by the learning apparatus 100, and the determination apparatus 200 refers to the stored determination learning models for determining whether a file is malware.

The learning apparatus 100 is an apparatus for creating the determination learning model trained with the feature of malware as a sample. The learning apparatus 100 includes a control unit 110 and a memory unit 120. The learning apparatus 100 may also include an input unit, an output unit, etc. as a communication unit to communicate with the determination apparatus 200, the Internet, or the like, or as an interface with a user, an operator, or the like, if necessary.

The memory unit 120 stores information necessary for the operation of the learning apparatus 100. The memory unit 120 is a non-volatile memory unit (storage unit), and is, for example, a non-volatile memory such as a flash memory or a hard disk. The memory unit 120 includes a feature setting memory unit 121 for storing feature setting information necessary for creating feature data and pseudo feature data, a pseudo feature data memory unit 122 for storing the pseudo feature data, a pseudo learning model memory unit 123 for storing pseudo learning models, and a feature data memory unit 124 for storing the feature data. The memory unit 120 further stores a program or the like necessary for creating the learning model by machine learning.

The control unit 110 is for controlling the operations of each unit of the learning apparatus 100, and is a program execution unit such as a CPU (Central Processing Unit). The control unit 110 reads the program stored in the memory unit 120 and executes the read program to implement each function (processing). As this function, the control unit 110 includes, for example, a pseudo feature creation unit 111, a pseudo learning unit 112, a learning preparation unit 113, a feature creation unit 114, and a determination learning unit 115.

The pseudo feature creation unit 111 creates pseudo feature data indicating the pseudo feature of a normal file. The pseudo feature creation unit 111 creates the pseudo feature data of the normal files by referring to the feature setting information in the feature setting memory unit 121, and stores the created pseudo feature data in the pseudo feature data memory unit 122. The pseudo feature creation unit 111 creates the pseudo feature data so as to cover possible values of the feature data based on the feature setting information such as a feature creation rule. Note that the pseudo feature creation unit 111 may acquire the created pseudo feature data.

The pseudo learning unit 112 performs pseudo learning as initial learning performed in advance of the learning of the malware. The pseudo learning unit 112 creates the pseudo learning model based on the pseudo feature data of the normal files stored in the pseudo feature data memory unit 122, and stores the created pseudo learning model in the pseudo learning model memory unit 123. The pseudo learning unit 112 creates the pseudo learning model by training a machine learner using a Neural Network (NN) with the pseudo feature data of the normal files as pseudo supervised data.

The learning preparation unit 113 performs preparation necessary for learning the determination learning model. The learning preparation unit 113 refers to the malware memory apparatus 300 to prepare samples of malware and selects the samples of the malware for learning. The learning preparation unit 113 may prepare and select the sample based on a predetermined standard, or may prepare and select the samples according to an input operation of the user or the like.

The feature creation unit 114 creates feature data indicating the features of the malware. The feature creation unit 114 refers to the feature setting information of the feature setting memory unit 121, creates the feature data of the selected malware, and stores the created feature data in the feature data memory unit 124. The feature creation unit 114 extracts the feature data of the selected malware based on the feature setting information such as the feature creation rule.

The determination learning unit 115 learns the feature data of the malware as final learning after the initial learning. The determination learning unit 115 creates the determination learning model based on the pseudo learning model stored in the pseudo learning model memory unit 123 and the feature data of the malware stored in the feature data memory unit 124, and stores the created determination learning model in the determination learning model memory apparatus 400. The determination learning unit 115 creates the determination learning model by training a machine learner by a neural network to add the feature data of the malware as the supervised data to the pseudo learning model.

The determination apparatus 200 determines whether or not a file provided by the user is malware. The determination apparatus 200 includes an input unit 210, a determination unit 220, and an output unit 230. The determination apparatus 200 may also include a communication unit to communicate with the learning apparatus 100, the Internet, or the like, if necessary.

The input unit 210 acquires a file input from the user. The input unit 210 receives the uploaded file via a network such as the Internet.

The determination unit 220 determines whether or not the input file is malware or a normal file based on the determination learning model created by the learning apparatus 100. The determination unit 220 refers to the determination learning model stored in the determination learning model memory apparatus 400 and determines whether features of the input file are close to the features of the malware or the features of the normal files.

The output unit 230 outputs a result of determining whether the input file is malware obtained by the determination unit 220 to the user. The output unit 230 outputs the result of determining whether the file is malware via a network such as the Internet, in a manner similar to the input unit 210.

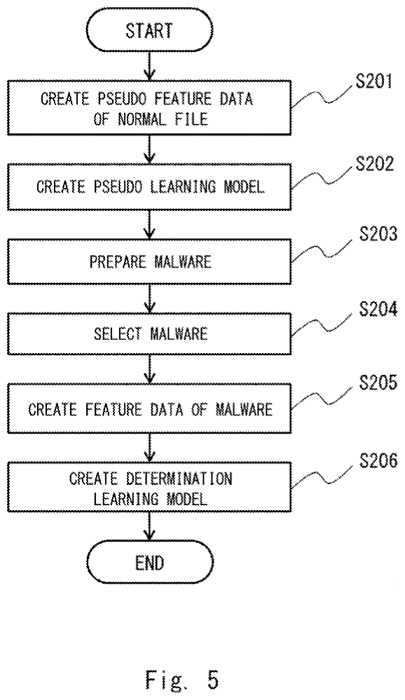

FIG. 5 shows a learning method implemented by the learning apparatus 100 according to this example embodiment. As shown in FIG. 5, first, the learning apparatus 100 creates the pseudo feature data of the normal file (S201). That is, the pseudo feature creation unit 111 creates the pseudo feature data of the normal file that covers the possible values of the feature data within a possible range. Next, the learning apparatus 100 creates the pseudo learning model (S202). That is, the pseudo learning unit 112 creates the pseudo learning model using the pseudo feature data of the normal files.

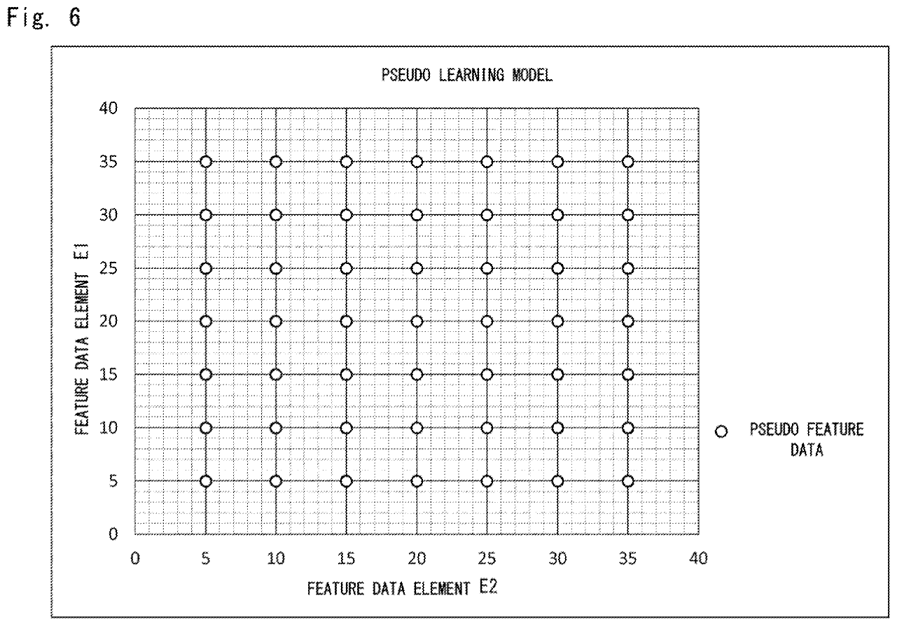

FIG. 6 shows an image of the pseudo feature data and the pseudo learning model in S201 and S202. The pseudo feature data is numerical data of a plurality of feature data elements. The feature data elements of the pseudo feature data correspond to the feature data elements of the feature data of the malware. That is, the feature data element of the pseudo feature data is a feature data element that the feature data of the malware can have, and is the same feature data element as the feature data of the malware. The feature data element is defined by the feature setting information of the feature setting memory unit 121, and is, for example, the number of occurrences of a predetermined string pattern. The predetermined string may be 1 to 3 characters or a string of any length. The feature data element may be an element that can be a common feature of malware, or may be the number of accesses to a predetermined file, the number of calls of a predetermined API, or the like.

FIG. 6 shows an example of two-dimensional feature data elements of feature data elements E1 and E2. For example, the feature data elements E1 and E2 are the number of occurrences of different string patterns. More feature data elements are preferably used to improve the accuracy of determining whether a file is malware. For example, 100 to 200 patterns for each of 1 character, 2 characters, and 3 characters may be prepared, and the number of occurrences of all patterns may be used as the feature data elements.

The pseudo feature data is data within a predetermined range (scale) of data in which the feature data can fall in the feature data element. For example, a minimum value and a maximum value indicating the range of the feature data elements are defined by the feature setting information in the feature setting memory unit 121. FIG. 6 shows an example in which the number of occurrences of a predetermined string pattern is within the range of 0 to 40. For example, the range may be set to 0 to 10,000. The range of the feature data elements is preferably a possible range (assumed range) of data in which the feature data of the malware can fall.

The pseudo feature data is data plotted at predetermined intervals as possible values of the feature data in the feature data element. FIG. 6 shows an example in which the interval of the number of occurrences of a predetermined string pattern is 5. The interval of the number of occurrences of a predetermined string pattern is not limited to this, and instead, the interval may be set to, for example, 1. The narrower the interval of the pseudo feature data, the higher the accuracy of determining whether a file is malware. However, if the interval between pseudo feature data is narrowed, the amount of data may become enormous. For this reason, it is preferable that the interval of the pseudo feature data be narrow within an allowable range in terms of the performance of the system and the apparatus.

As shown in FIG. 6, as pseudo feature data of a normal file covering possible values of the feature data, for example, in the feature data elements E1 and E2, data having an interval of 5 within a range of 0 to 40 is created, and a pseudo learning model is created using the pseudo feature data as the pseudo supervised data. With this pseudo learning model, any sample can be determined to be a “normal file”. That is, by using data covering possible values that the feature data can have as the pseudo feature data of the normal file, it is possible to create a pseudo learning model in which all the input files can be determined to be the “normal files”.

Next, as shown in FIG. 5, the learning apparatus 100 prepares samples of the malware (S203) and selects the malware to be used for learning (S204). That is, the learning preparation unit 113 prepares only a large number of samples of the malware from the malware memory apparatus 300, the Internet, or the like. Further, the learning preparation unit 113 selects malware for learning from the prepared malware based on predetermined standard or the like.

Next, the learning apparatus 100 creates feature data of malware (S205). That is, the feature creation unit 114 extracts the feature amount of the malware to be learned as a sample and creates the feature data of the malware. Next, the learning apparatus 100 creates the determination learning model (S206). That is, the determination learning unit 115 additionally trains the pseudo learning model with the feature data of the malware to create the determination learning model.

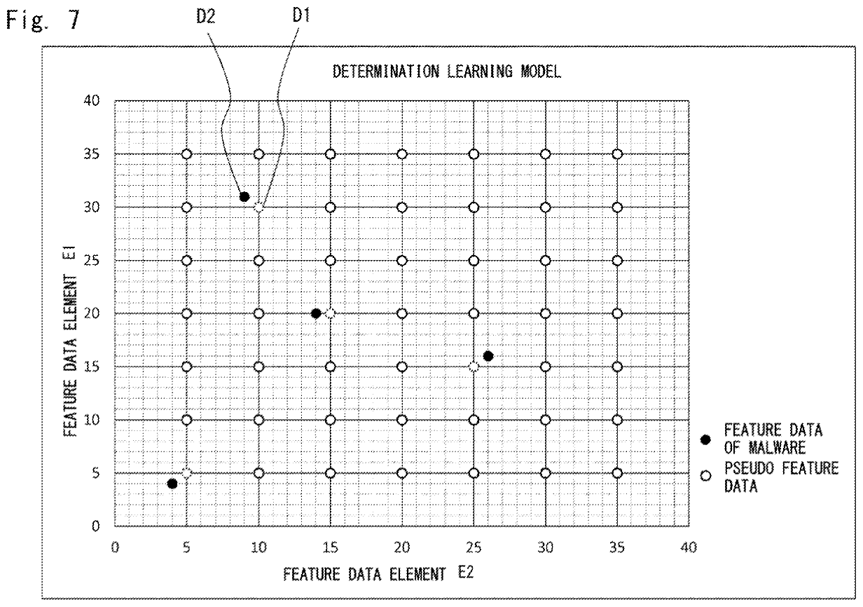

FIG. 7 shows an image of the feature data and the determination learning model of the malware obtained in S205 and S206. The feature data of the malware is numerical data of a plurality of feature data elements, in a manner similar to the pseudo feature data of FIG. 6. For example, for each of the feature data elements E1 and E2, which are the number of occurrences of different string patterns, the feature amount of the malware of the sample is extracted and used as the feature data. The pseudo learning model as shown in FIG. 6 is additionally trained with the feature data of the malware as the supervised data, and the determination learning model as shown in FIG. 7 is obtained. At this time, when the feature data of the malware to be learned is close to the pseudo feature data, the pseudo feature data is overwritten by the feature data. That is, the closest pseudo feature data within a predetermined range (e.g., closer than ½ of the interval of the pseudo feature data) is deleted, and the feature data is added. For example, in FIG. 7, since pseudo feature data D1 is present closest to feature data D2, the pseudo feature data D1 is deleted and the feature data D2 is added.

As shown in FIG. 7, only the feature data of the malware is learned, and a determination learning model trained with the feature of the malware is created. Since the learning is divided into two stages, the pseudo feature data is not learned at this stage, and the pseudo feature data close to the feature data of the malware is overwritten. The determination learning model capable of determining whether a file is malware or a normal file can be created by overwriting the feature data used for determining whether a file is malware while leaving the pseudo feature data used for determining whether a file is a normal file.

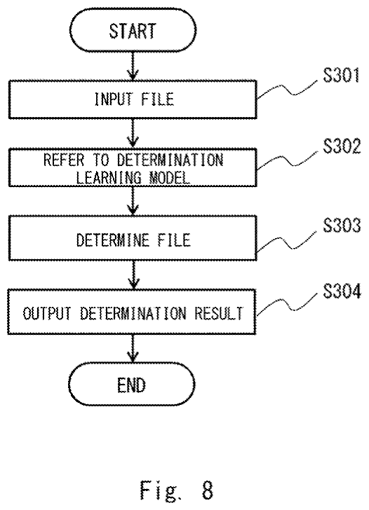

FIG. 8 shows a determination method implemented by the determination apparatus 200 according to this example embodiment. This determination method is executed after the determination learning model is created by the learning method shown in FIG. 5. In this determination method, a determination learning model may be created by the learning method shown in FIG. 5.

As shown in FIG. 8, the determination apparatus 200 receives an input of a file from the user (S301). For example, the input unit 210 provides a web interface to the user and acquires the file uploaded by the user on the web interface.

Next, the determination apparatus 200 refers to the determination learning model (S302) and determines the file based on the determination learning model (S303). The determination unit 220 refers to the determination learning model created as shown in FIG. 7 and then determines whether the input file is malware or a normal file. A file having the features of the malware learned by the determination learning model is determined to be “malware”, while a file not having such features is determined to be a “normal file”. The feature amount of the input file may be extracted and determined by the feature data closer than a predetermined range in the determination learning model. For example, when the data closest to the feature amount of the input file is the feature data of the malware, the input file is determined to be malware, while when the data closest to the feature amount of the input file is the pseudo feature data of the normal file, the input file is determined to be a normal file.

Next, the determination apparatus 200 outputs the result of determining whether a file is malware or a normal file (S304). For example, the output unit 230 displays the result of determining whether a file is malware or a normal file to the user via the web interface, as in S301. For example, “File is malware” or “File is a normal file” is displayed. In addition, a possibility (probability) that the file may be determined to be malware or a normal file from the distance between the feature amount of the file and the feature data of the determination learning model may be displayed.

As described above, in this example embodiment, the learning is performed in two stages: one stage of “creation of a pseudo learning model by learning pseudo feature data”; and a stage of “creation of a determination learning model by feature data of actual malware”. In particular, a determination learning model is created without using a sample or feature data of a normal file. A pseudo learning model can be created by using data covering a range of values (integer values) that feature data can fall in as “pseudo feature data of a normal file” and creating a pseudo learning model only with the pseudo feature data, thereby making it possible to create a pseudo learning model that determines all the files to be “normal files”. Further, the pseudo learning model additionally trained with the feature data of the malware is created as the “determination learning model”, and the feature of the malware is learned by overwriting the pseudo learning model to create the determination learning model. In this manner, the malware can be accurately determined using the determination learning model.

### Second Example Embodiment

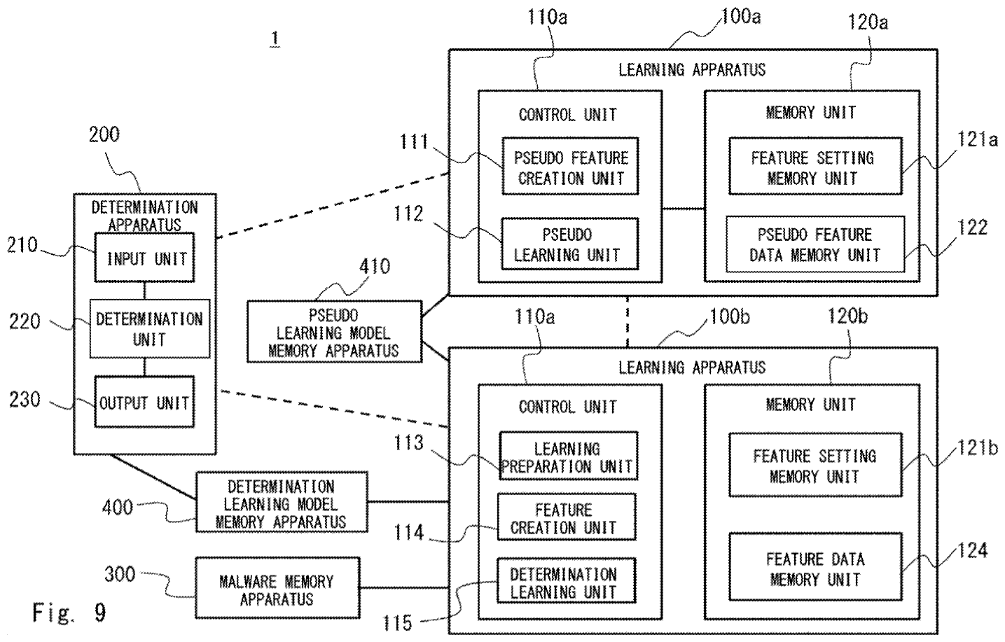

Next, a second example embodiment will be described. In this example embodiment, another configuration example of the learning apparatus according to the first example embodiment will be described. That is, as shown in FIG. 9, the learning apparatus 100 may be divided into a learning apparatus 100a for creating pseudo learning models and a learning apparatus 100b for creating determination learning models.

For example, the learning apparatus 100a includes the pseudo feature creation unit 111 and the pseudo learning unit 112 in a control unit 110a, and includes a feature setting memory unit 121a and a pseudo feature data memory unit 122 in a memory unit 120a. The learning apparatus 100a creates a pseudo learning model, and stores the created pseudo learning model in a pseudo learning model memory apparatus 410 in a manner similar to that in the first example embodiment.

The learning apparatus 100b includes the learning preparation unit 113, the feature creation unit 114, and the determination learning unit 115 in the control unit 110b, and includes a feature setting memory unit 121b and a feature data memory unit 124 in a memory unit 120b. The learning apparatus 100b creates a determination learning model using a pseudo learning model or the like of the pseudo learning model memory apparatus 410 in a manner similar to that in the first example embodiment.

With such a configuration, a pseudo learning model can be created in advance, and then a determination learning model can be created using the pseudo learning model at the timing of learning malware. The pseudo learning model can be reused as a common model to create the determination learning model.

Note that the present disclosure is not limited to the example embodiments described above, and may be changed as necessary without departing from the scope thereof. For example, the system may be used not only to determine a file provided by a user but also to determine an automatically collected file. Furthermore, the system may be used not only for determining whether a file is malware or a normal file but also for determining whether a file is other abnormal files or normal files.

Each configuration in the above example embodiments may composed of hardware or software, or both of them, or may be composed of one piece of hardware or software, or may be composed of a plurality of pieces of hardware or software. The function (processing) of each apparatus may be implemented by a computer including a CPU, a memory or the like. For example, a program for performing the method (the learning method or determination method) in the example embodiments may be stored in the memory apparatus, and each function may be implemented by executing the program stored in the memory apparatus by the CPU.

These programs can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Although the present disclosure has been described with reference to the above example embodiments, the present disclosure is not limited to the above example embodiments. Various changes can be made to the configurations and details of this disclosure that can be understood by those skilled in the art within the scope of this disclosure.

The whole or part of the exemplary embodiment disclosed above can be described as, but not limited to, the following supplementary notes.

### Supplementary Note 1

A learning apparatus comprising:

pseudo learning means for creating a pseudo learning model based on pseudo feature data indicating a pseudo feature of goodware; and

determination learning means for creating a determination learning model for determining whether a file is malware based on the created pseudo learning model and feature data indicating a feature of the malware.

### Supplementary Note 2

The learning apparatus according to Supplementary note 1, wherein

the pseudo feature data is data of a feature data element that the feature data can have.

### Supplementary Note 3

The learning apparatus according to Supplementary note 2, wherein

the pseudo feature data is data within a range of data that the feature data can fall in the feature data element.

### Supplementary Note 4

The learning apparatus according to Supplementary note 2 or 3, wherein

the pseudo feature data is data plotted at predetermined intervals in the feature data element.

### Supplementary Note 5

The learning apparatus according to any one of Supplementary notes 2 to 4, wherein

the feature data element includes the number of occurrences of a predetermined string pattern.

### Supplementary Note 6

The learning apparatus according to any one of Supplementary notes 2 to 5, wherein

the feature data element includes the number of accesses to a predetermined file.

### Supplementary Note 7

The learning apparatus according to any one of Supplementary notes 2 to 6, wherein

the feature data element includes the number of calls of a predetermined application interface.

### Supplementary Note 8

The learning apparatus according to any one of Supplementary notes 1 to 7, wherein

the determination learning means creates the determination learning model by adding the feature data to the pseudo learning model.

### Supplementary Note 9

The learning apparatus according to Supplementary note 8, wherein

the determination learning means creates the determination learning model by overwriting the pseudo feature data with the feature data in the pseudo learning model.

### Supplementary Note 10

A determination system comprising:

pseudo learning means for creating a pseudo learning model based on pseudo feature data indicating a pseudo feature of goodware;

determination learning means for creating a determination learning model for determining whether an input file is malware based on the created pseudo learning model and feature data indicating a feature of the malware; and

determination means for determining whether or not the input file is the malware based on the created determination learning model.

### Supplementary Note 11

The determination system according to Supplementary note 10, wherein

the determination means makes the determination based on the feature of the file and the feature data in the determination learning model.

### Supplementary Note 12

A learning method comprising:

creating a pseudo learning model based on pseudo feature data indicating a pseudo feature of goodware; and

creating a determination learning model for determining whether a file malware based on the created pseudo learning model and feature data indicating a feature of the malware.

### Supplementary Note 13

The learning method according to Supplementary note 12, wherein

the pseudo feature data is data of a feature data element that the feature data can have.

### Supplementary Note 14

A learning program for causing a computer to execute: creating a pseudo learning model based on pseudo feature data indicating a pseudo feature of goodware; and

creating a determination learning model for determining whether a file is malware based on the created pseudo learning model and feature data indicating a feature of the malware.

### Supplementary Note 15

The learning program according to Supplementary note 14, wherein

the pseudo feature data is data of a feature data element that the feature data can have.

This application is based upon and claims the benefit of priority from Japanese patent application No. 2019-175847, filed on Sep. 26, 2019, the disclosure of which is incorporated herein in its entirety by reference.

### REFERENCE SIGNS LIST

1, 2 DETERMINATION SYSTEM
10 LEARNING APPARATUS
11 PSEUDO LEARNING UNIT
12 DETERMINATION LEARNING UNIT
20 DETERMINATION APPARATUS
21 DETERMINATION UNIT
100, 100a, 100b LEARNING APPARATUS
110, 110a, 110b CONTROL UNIT
111 PSEUDO FEATURE CREATION UNIT
112 PSEUDO LEARNING UNIT
113 LEARNING PREPARATION UNIT
114 FEATURE CREATION UNIT
115 DETERMINATION LEARNING UNIT
120, 120a, 120b MEMORY UNIT
121, 121a, 121b FEATURE SETTING MEMORY UNIT
122 PSEUDO FEATURE DATA MEMORY UNIT
123 PSEUDO LEARNING MODEL MEMORY UNIT
124 FEATURE DATA MEMORY UNIT
200 DETERMINATION APPARATUS
210 INPUT UNIT
220 DETERMINATION UNIT
230 OUTPUT UNIT
300 MALWARE MEMORY APPARATUS
400 DETERMINATION LEARNING MODEL MEMORY APPARATUS
410 PSEUDO LEARNING MODEL MEMORY APPARATUS

What is claimed is:

1. A learning apparatus comprising:
a memory storing instructions, and
a processor configured to execute the instructions stored in the memory to;
create a pseudo learning model based on pseudo feature data indicating a pseudo feature of goodware; and
create a determination learning model for determining whether a file is malware based on the created pseudo learning model and feature data indicating a feature of the malware.

2. The learning apparatus according to claim 1, wherein
the pseudo feature data is data of a feature data element that the feature data can have.

3. The learning apparatus according to claim 2, wherein
the pseudo feature data is data within a range of data that the feature data can fall in the feature data element.

4. The learning apparatus according to claim 2, wherein
the pseudo feature data is data plotted at predetermined intervals in the feature data element.

5. The learning apparatus according to claim 2, wherein
the feature data element includes the number of occurrences of a predetermined string pattern.

6. The learning apparatus according to claim 2, wherein
the feature data element includes the number of accesses to a predetermined file.

7. The learning apparatus according to claim 2, wherein
the feature data element includes the number of calls of a predetermined application interface.

8. The learning apparatus according to claim 1, wherein
the processor is further configured to execute the instructions stored in the memory to create the determination learning model by adding the feature data to the pseudo learning model.

9. The learning apparatus according to claim 8, wherein
the processor is further configured to execute the instructions stored in the memory to create the determination learning model by overwriting the pseudo feature data with the feature data in the pseudo learning model.

10. A determination system comprising:
a memory storing instructions, and
a processor configured to execute the instructions stored in the memory to;
create a pseudo learning model based on pseudo feature data indicating a pseudo feature of goodware;
create a determination learning model for determining whether an input file is malware based on the created pseudo learning model and feature data indicating a feature of the malware; and
determine whether or not the input file is the malware based on the created determination learning model.

11. The determination system according to claim 10, wherein
the processor is further configured to execute the instructions stored in the memory to make the determination based on the feature of the file and the feature data in the determination learning model.

12. A learning method comprising:
creating a pseudo learning model based on pseudo feature data indicating a pseudo feature of goodware; and
creating a determination learning model for determining whether a file is malware based on the created pseudo learning model and feature data indicating a feature of the malware.

13. The learning method according to claim 12, wherein
the pseudo feature data is data of a feature data element that the feature data can have.

14. A non-transitory computer readable medium storing a learning program for causing a computer to execute:
creating a pseudo learning model based on pseudo feature data indicating a pseudo feature of goodware; and
creating a determination learning model for determining whether a file is malware based on the created pseudo learning model and feature data indicating a feature of the malware.

15. The non-transitory computer readable medium according to claim 14, wherein
the pseudo feature data is data of a feature data element that the feature data can have.
